(19) United States
(12) Patent Application Publication
(10) Pub. No.: US 2024/0196919 A1
(43) Pub. Date: Jun. 20, 2024

(54) COFFEE-BASED FOOD COMPOSITION AND PRODUCTION METHOD THEREFOR

(71) Applicant: LA COFFOLATERIE SA, Meyrin (CH)

(72) Inventors: Bertrand Baud, Genève (CH); Marc-André Cartier, Collex (CH)

(21) Appl. No.: 18/264,290

(22) PCT Filed: Feb. 4, 2022
(86) PCT No.: PCT/EP2022/052762

§ 371 Date: Jan. 29, 2024

(30) Foreign Application Priority Data
Feb. 4, 2021 (WO) PCT/EP2021/052671

(51) Int. Cl. A23F 5/14; A23F 5/04; A23F 5/08; A23G 1/48

(52) U.S. Cl. CPC A23F 5/14; A23F 5/04; A23F 5/08; A23G 1/48

(57) ABSTRACT

The invention relates to a method for preparing of a so-called basic composition, preferably food, the method comprising:
Providing a fat and a roasted coffee grind;
Mixing the fat and the grind to obtain the basic preparation,
the method being characterized in that
the mixture has a particle size comprised between about 5 μm and about 25 μm;
the mixing is carried out at a temperature above about 28° C. and below about 85° C.

The invention also concerns a method for preparing a so-called final composition from said basic composition.

The invention finally concerns a composition, preferably food, obtained according to any of the methods according to the invention.

### TECHNICAL FIELD OF THE INVENTION

The invention concerns a method for preparing a so-called basic composition.

The invention also concerns a method for manufacturing a final composition comprising said basic composition.

The invention also concerns a basic composition and a final composition, as well as a food product comprising said basic or final composition.

### STATE OF THE ART

Today, there are mainly two types of preparation for consuming coffee, namely the liquid preparations obtained by extraction and hot or cold infusion, and the solid preparations where beans or a powder of more or less brewed beans solid coffee are directly used.

However, the vast majority of coffee is consumed in a liquid preparation, in particular because the use of solid coffee has several drawbacks. For example, coffee powder is hard to shape and it is difficult to agglomerate, which complicates the production of a solid coffee-based preparation.

Moreover, once incorporated according to existing techniques, the beans persist in the final preparation, which can alter the organoleptic pleasure of the consumer.

Finally, the coffee beans in the preparation impart an often excessive bitterness to the finished product.

Thus, there is a need to improve the methods of solid coffee or grind-based preparations in order to overcome the drawbacks of the existing techniques.

An object of the present invention is therefore to solve, or at least to minimize, the drawbacks of the methods for solid preparations based on existing bean or grinding coffee described above.

In particular, one of the objects of the present invention is to improve the incorporation of coffee, for example of the coffee beans grind, into the solid preparation.

### SUMMARY OF THE INVENTION

These objects are at least partially achieved by the present invention, a first aspect of which concerns a method for preparing a so-called basic composition, preferably food, the method comprising:
Providing a fat and a roasted coffee grind;
Mixing the fat and the grind to obtain the basic preparation, the method being characterized in that
the mixture has a particle size comprised between about 5 μm and about 25 μm;
the mixing is carried out at a temperature above about 28° C. and below about 85° C.

According to a second aspect, the invention concerns a method for preparing a so-called final composition, the method comprising:
Providing a so-called basic composition obtained by a method according to the invention;
Adding to the basic composition one or more additives;
Preparing said final composition by mixing said basic composition with said additive until a homogeneous mixture is obtained;
According to a third aspect, the invention concerns a composition, preferably food, obtained according to one of the methods according to the invention.

### DESCRIPTION OF FIGURES

FIG. 1 is a photograph of a micron ruler for measuring the particle size of the mixture within the meaning of the present invention. Said micron ruler comprises a graduation in μm (1) and a groove (2) the depth of which is equal to the value of the graduation in μm. In order to measure the particle size of a composition, a sample of the composition (10 g for this model) is deposited at the start of the groove, at the height of the graduation indicating 0 μm, then the composition is scraped off using a suitable squeegee so as to push the composition in the direction of the graduation indicating 100 μm. The particles are thus pushed until the groove becomes deep enough for the smallest particles of the sample to be completely erased in the depth of the groove and can no longer be pushed by the squeegee. The particle size of the smallest particles is thus determined by the smallest graduation at which the composition is visible in the groove after scraping (3). In the example of FIG. 1, this particle size is about 10 μm.

### DETAILED DESCRIPTION OF THE INVENTION

The present invention makes it possible to solve, or at least to minimize, the drawbacks of the methods for solid preparations based on existing bean or grinding coffee described above.

To this end, the present invention relates, according to a first aspect, to a method for preparing a so-called basic composition, preferably food, the method comprising:
Providing a fat and a roasted coffee grind;
Mixing the fat and the grind to obtain the basic preparation, the method being characterized in that
the mixture has a particle size comprised between about 5 μm and about 25 μm;
the mixing is carried out at a temperature above about 28° C. and below about 85° C.

In the present invention, the basic composition is obtained from at least two raw materials, namely a fat and a coffee grind.

The coffee which is mixed with the fat must be ground (brewed) to reach a controlled particle size comprised between about 5 μm and about 25 μm (by about is meant a difference of +/−1 micron). This particle size makes it possible to avoid the grainy sensation that the consumer can detect when he consumes compositions based on solid coffee (coffee grind, for example) prepared according to existing methods. Thanks to this controlled particle size, the consumer does not perceive or perceives little enough the presence of solid coffee in the (basic or final) composition. The consumer detects the presence of coffee only by taste, appearance and smell.

Advantageously, this controlled grind particle size also facilitates the incorporation of the grind coffee particles into the fat and vice versa.

The fat is preferably a fat having controllable ductility and viscosity which vary as a function of temperature. In addition, the fat is preferably selected so as to allow simplified control of the physical state of said fat (namely the liquid, semi-liquid, semi-solid and solid states) in an easily controllable range of temperatures and close to room temperature. As an example of such a fat, mention may be made of cocoa butter, which is a preferred fat for carrying out the present invention.

The desired particle size of the mixture can be obtained by two alternative methods. The steps consisting, on the one hand of supplying a fat and a roasted coffee grind and on the other hand of mixing the coffee grind and the fat may either be separate steps or be carried out in a single step. In the first case, the coffee is ground to reach a particle size comprised between about 5 μm and about 25 μm before being mixed with the fat. In the second case, the coffee is mixed with the fat in the form of whole beans or in the form of a coffee grind of a coarser grain size (namely in the form of a grind with a grain size greater than 25 μm), then the mixture comprising the coffee beans or said coarser grind and the fat is ground to reach a particle size comprised between about 5 μm and about 25 μm. In other words, the coffee is mixed with the fat, then the whole is then ground until the mixture reaches the target particle size between about 5 μm and about 25 μm.

It is advantageous to mix the coffee with the fat before grinding the whole
to gradually incorporate the fat into the beans;
so as not to overheat the beans during grinding;
to obtain a stable, controllable and pleasant mixture.

The mixing between the coffee grind and the fat is carried out at a controlled temperature which is above about 28° C. and below about 85° C. This temperature is selected to facilitate the incorporation of the coffee grind into the fat. If the temperature is lower than about 28° C., the mixing between the grind and the fat is not or not correctly done. If the temperature is above about 85° C., the mixing is not optimal. The mixing is negatively affected by heat and risks various issues including, but not limited to, potential over-roasting. This can result in a deterioration of the organoleptic properties of the obtained composition.

In a preferred embodiment, a controlled temperature between about 40° C. and 60° C. makes it possible not to over-roast the coffee which is already roasted beforehand.

Advantageously, the mixing is carried out at a temperature comprised between about 35° C. and about 70° C., preferably between about 40° C. and about 65° C.; preferably between about 50° C. and about 65° C., preferably between about 40° C. and 60° C., preferably between about 40° C. and about 50° C.

Advantageously, the basic preparation has a solid or at least partially solid state at a temperature comprised between about 20° C. and 35° C., preferably between 25° C. and about 32° C., and a liquid or at least partially liquid at a temperature above about 35° C., preferably 32° C. This allows optimal solidification of the basic preparation, in particular better structuring of the fat. This also allows better control of the texture and state of the basic composition, the final composition and the product.

Advantageously, the mixture is ground to reach a particle size comprised between about 5 μm and about 25 μm, preferably between about 15 μm and about 18 μm.

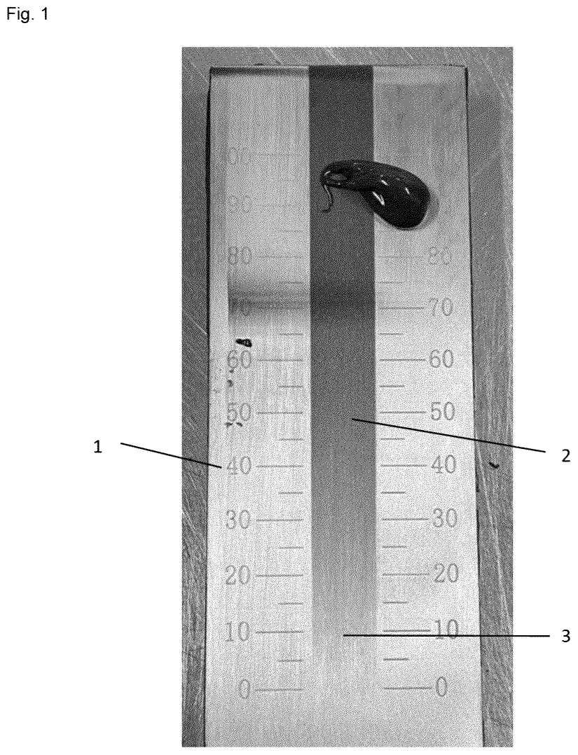

For example, the particle size is measured with a micron ruler or an appropriate sieve. By way of illustration, a micron ruler is represented in FIG. 1. The techniques of the micron ruler and the sieve make it possible to determine the size of the smallest particles contained in the sample whose particle size is to be measured. Thus, the particle size ranges within the meaning of the present invention refer to the size of the smallest particles of the mixture, as detected by a measuring method such as a micron ruler or a sieve. The grain size ranges as defined above allow to have maximum taste, in particular maximum finesse in the mouth, for minimum texture.

This also makes it possible to be able to produce the basic composition easily while maintaining accessible particle sizes by following the working methods and by using devices known to those skilled in the art, without the need for specific adaptation, for example in the know-how or help or equipment.

Advantageously, the method comprises:
Mixing:
between about 15% m/m and 85% m/m of fat, preferably between 20% m/m and 50% m/m of fat, preferably between 20 and 45% m/m, between 20 and 40% m/m, between 25 and 40% m/m or between 25% m/m and 45% m/m of fat, preferably between 30% m/m and 40% m/m of fat, preferably between 34% m/m and 37% m/m of fat; and
between about 1% m/m and 60% m/m of grind, preferably between 5% m/m and 35% m/m of grind, preferably between 10% m/m and 30% m/m of grind, preferably between 10% m/m and 25% m/m of grind, preferably between 10% m/m and 20% m/m of grind, preferably between 15% m/m and 20% m/m of grind, preferably between 16% m/m and 19% m/m of grind;

Advantageously, the stability of the product as well as the texture, and the control of the states are facilitated by proportions equivalent to these (above). These proportions also make it possible to guarantee a taste and gustatory pleasure to the consumer to prevent him from being saturated (even quickly disgusted) by the product.

The viscosity of the basic composition determines in particular the ability to work this composition, in particular with a view to preparing a final composition by mixing the basic composition with additives or with a view to giving the composition a particular shape. A composition that is too viscous, that is having a viscosity greater than 50 Pa·s will for example be difficult to work with, to mix with other ingredients or will be unsuitable for the production of certain categories of final compositions. A composition having a too low viscosity, namely a viscosity of less than 0.5 Pa·s, will, on the contrary, lack staying power. Basic compositions having an appropriate viscosity, namely a viscosity comprised between 0.5 and 50 Pa·s are typically obtained when the proportion of fat in the mixture is comprised between about 15% m/m and 85% m/m of fat.

Preferably, the basic composition is characterized by a viscosity between 5 and 25 Pa·s, which makes it possible to work the basic composition in an optimal manner for a greater variety of end uses. Such a viscosity is typically obtained when the proportion of fat in the mixture is comprised between 20% m/m and 50% m/m, preferably between 20 and 45% m/m, between 20 and 40% m/m, between 25 and 45% m/m, or between 25% m/m and 40% m/m.

The viscosity is preferably defined as the viscosity measured using a rotational viscometer.

Advantageously, the fat is selected from cocoa butter, coconut butter, illipe butter, shea butter, a solid fat at a temperature of less than 28° C. Preferably the fat is cocoa butter for a solid result or oil for a liquid, semi-liquid or viscous result.

According to a preferred embodiment, the fat is cocoa butter.

Advantageously, the method comprises:
Providing coffee beans to roast; and
Roasting the coffee beans according to a determined roasting method; or
Providing roasted coffee beans directly.

Advantageously, the method comprises:

Preparing the roasted coffee grind by grinding roasted coffee beans, for example by mixing and friction preferably in a ball mill or by crushing the coffee beans preferably in a cylinder or roller mill and more preferably in a ball mill. This grinding technique, and more particularly the use of a ball mill, makes it possible to obtain the desired particle size, after a grinding time of about 2 to 3 hours. The duration of the grinding is considerably less than that required for the grinding of cocoa beans with a view to the manufacture of chocolate, which makes the method of the present invention particularly effective.

This grinding technique, as well as the use of coffee instead of cocoa beans, makes it possible to obtain a basic composition which can be worked so as to obtain final compositions having various textures and various shapes without requiring conching step. Thus, in a preferred aspect of the invention, the method does not comprise a conching step. The conching, which is necessary in the chocolate manufacturing method, consists of intense and long kneading necessary to improve the fluidity and plasticity of a mass. The possibility of avoiding the conching step in the method of the present invention makes it possible to significantly reduce the duration and complexity of the manufacturing method and to make the method significantly more economical and in particular to increase the yield and reduce consumption of energy.

According to a second aspect, the present invention concerns a method for preparing a so-called final composition, the method comprising:
Providing a so-called basic composition obtained by a method according to the invention;
Adding to the basic composition one or more additives;
Preparing said final composition by mixing said basic composition with said additive until a homogeneous mixture is obtained;
Advantageously, the present invention allows the development of a single basic composition which can provide final compositions of several different types depending on the needs, for example, a solid final composition in the form of a tablet and a spread. Other products are also possible, such as individual Neapolitans, product pistols, product pellets, different moldings, subjects or sculptures, coating mass, aromatic mass.

The present invention makes it possible to prepare coffee-based compositions allowing 100% consumption of the coffee bean without the disturbing problem or the inconvenience of pure consumption of the bean, such as granularity or bitterness.

Advantageously, the composition is a product selected from tablets, pellets, spreads, a pastry mass (used in different forms by those skilled in the art after having melted it to make moldings or mixtures), a coating mass (more solid than the pastry mass to be reworked in particular in pastry), a raw mass (basic product for chocolate makers for example).

According to a third aspect, the present invention concerns a composition, preferably food, obtained according to one of the methods according to the invention.

According to a preferred embodiment, the composition is a food composition intended for the consumer.

The invention according to the present invention may comprise one embodiment or several embodiments in combination.

### DESCRIPTION OF EMBODIMENTS OF THE INVENTION

This description is given on a non-limiting basis, each characteristic of an embodiment can be combined with any other characteristic of any other embodiment in an advantageous manner.

### Example 1: Preparation of a Basic Preparation

Mixing roasted coffee beans 58% m/m and cocoa butter 42% m/m;
Grinding the mixture to 17 microns at 62° C. for 5 hours in a ball mill.

### Example 2

In this example 2, the basic composition according to example 1 was used to form a final composition in the form of a product corresponding to a spread which has the following composition:
38.17% m/m sugar
15.40% m/m hazelnut
13.75% m/m milk powder
16.71% m/m sunflower oil
8.80% m/m coffee
6.60% m/m cocoa butter
Remains at 100% emulsifier, here sunflower lecithin.

In this example 2, the spread was obtained using the following method:
providing the basic composition and adding the necessary quantities of sugar, hazelnut, powdered milk, sunflower oil, and emulsifier to reach the composition defined above and obtain a mixture;
grinding the mixture to 18 microns at a temperature of 65° C. for 4 hours in a ball mill;
potting the mixture directly at the outlet of the ball mill;
immerse the closed pots in boiling water for 20 minutes, then remove them and leave to sit for 12 hours in the absence of water;
the paste is left to cool for 24 h to remix at 45° C. before potting;
leaving in the fridge at 7° C. for 30 minutes then 24 hours at room temperature (21° C.).

### Example 3

In this example 3, the basic composition according to example 1 was used to form a product corresponding to a tablet which has the following composition:
17.8% m/m of coffee
35.5% cocoa butter
9.4% m/m whole milk
36.7% m/m sugar
Remains at 100% emulsifier, here sunflower lecithin.

In this example 3, the tablet or released product was obtained using the following method:
providing the basic composition and adding the necessary quantities of whole milk, sugar and emulsifiers to reach the composition defined above and obtain a mixture;
grinding the mixture to 18 microns at a temperature of 65° C. for 4 hours in a ball mill;
removing the product and temper it by lowering the temperature of the product evenly to a temperature comprised between 25.5° C. and 28° C.; then raising it to a temperature comprised between 28.1° C. and 32° C., preferably 26.5° C. then 29.2° C.;
once the product has been tempered, it is molded in a chocolate mold, preferably made of polycarbonate, to obtain the bar or the desired molding (pallets, pellets, moldings, or others);

### Example 4: Comparative Tests

The applicant carried out comparative tests which revealed the following characteristics:
if the particle size is greater than about 25 μm, the consumer has a strong perception of the coffee particles, in other words an unpleasant grain sensation;
if the mixing of the grind and the fat is carried out at a temperature above about 85° C., the coffee continues to roast or even burn;
if the mixing of the grind and the fat is carried out at a temperature below about 25° C., the fat does not melt, which prevents amalgamation between the fat and the grind;
if the temperature of the manufacturing method of the basic or final composition is uncontrolled, an absence of crystallization or a poor crystallization curve of the product is observed; in other words, the solidification is not satisfactory, the product is not solid, not brittle, not shiny, even it turns white;
if the grinding time is greater than about 8 hours, a product that is too dense and difficult to work is obtained.

Although the examples have been described by combining several embodiments, it is obvious that many variants, modifications and variations would be or are obvious to those skilled in the art. Accordingly, this disclosure is intended to encompass all such alternatives, modifications, equivalents and variations which are within the scope of this disclosure.

1. A method for preparing of a basic preparation, the method comprising:
Providing a fat and a roasted coffee grind;
Mixing the fat and the roasted coffee grind to obtain the basic preparation, the method being characterized in that
the basic preparation has a particle size between 5 μm and 25 μm;
wherein the mixing is carried out at a temperature above −28° C. and below −85° C.

2. The method according to claim 1, wherein said roasted coffee grind is ground to reach a particle size between 5 μm and 25 μm before being mixed with the fat.

3. The method according to claim 1, wherein a mixture comprising coffee in a form of whole beans or in a form of a grind having a particle size greater than 25 μm and fat is ground to reach the particle size between 5 μm and 25 μm.

4. The method according to claim 1, wherein the basic preparation has a solid or at least partially solid state at an ambient temperature of between −20° C. and 35° C., or between 25° C. and about 32° C., and a liquid or at least partially liquid state at a temperature above 3-5° C., or 32° C.

5. The method according to claim 1, wherein the method comprises:
grinding the fat and the roasted coffee grind to reach a particle size of between 10 μm and 20 μm.

6. The method according to claim 1, wherein the method comprises:
mixing the fat and the roasted coffee grind at a temperature between −35° C. and −70° C.

7. The method according to claim 1, wherein the method comprises:
mixing the fat and the roasted coffee grind:
wherein the fat is between about 15% m/m and 55% m/m; and
Wherein the roasted coffee grine is between about 1% m/m and 40% m/m.

8. The method according to claim 1, wherein the fat is cocoa butter, coconut butter, illipe butter, shea butter, or a fat that is solid at a temperature of less than around 28° C.

9. The method according to claim 1, wherein the method further comprises:
Providing coffee beans to roast;
Roasting the coffee beans according to a determined roasting method.

10. The method according to claim 1, wherein the method further comprises:
Preparing the roasted coffee grind by grinding roasted coffee beans or by crushing the coffee beans.

11. The method for preparing a final composition, the method comprising:
Providing the basic preparation obtained by a method according to claim 1;
Adding to the basic preparation one or more additives;
Preparing said final composition by mixing said basic preparation with said additive until a homogeneous mixture is obtained.

12. The method according to claim 11, wherein said additive is a dairy product, a sweetening product, an emulsifier, an oil, a fruit extract, nuts, or praline.

13. The method according to claim 11, wherein the method further comprises:
Mixing said basic preparation with said additive by grinding until the homogeneous mixture is obtained.

14. The method according to claim 11, wherein the mixing is carried out at a temperature of between −40° C. and 70° C.

15. The method according to claim 11, wherein the additive is a sweetening product, wherein a proportion of the sweetening product is between about 10% m/m and about 60% m/m.

16. The method according to claim 11, wherein the additive is a dairy product, wherein a proportion of the dairy product is at between 1% m/m and 30% m/m.

17. The method according to claim 11, wherein the additive is an emulsifier, wherein a proportion of the emulsifier is between 0.1% m/m and 5% m/m.

18. A composition, obtained according to the methods of claim 1.

19. The composition according to claim 18, wherein the composition is a product in a form of tablets, pastilles, spreads, a pastry mass, a couverture mass, a raking mass, and a raw mass.
